(19) United States
(12) Patent Application Publication
(10) Pub. No.: US 2021/0259169 A1
(43) Pub. Date: Aug. 26, 2021

(54) Bioponic agriculture

(71) Applicant: Marc-Andre Valiquette, Saint-Hyacinthe (CA)

(72) Inventor: Marc-Andre Valiquette, Saint-Hyacinthe (CA)

(21) Appl. No.: 16/796,064

(22) Filed: Feb. 20, 2020

(51) Int. Cl. A01G 24/15; A01C 1/00; A01G 9/14; G06K 9/00

(52) U.S. Cl. CPC A01G 24/15; G06K 9/00657; A01G 9/14; A01C 1/00

(57) ABSTRACT

There is provided an off-ground plant growing system providing an electronic monitoring system and also providing a thin layer of high porosity organic compost and providing the steps of adding a precise amount of vermicompost to the soil phase, immediately followed by addition of arbuscular mycorhizae, and followed by regular weekly addition of beneficial micro-organisms for plant development, including mycorhizae associated bacteria, plant growth promoting fungi, soil conditioning bacteria, purple non-sulphur bacteria and probiotic disease-preventing bacteria, in order to promote the creation of a well differentiated, dense and ramified root system and complete microrhizobiome in the compost phase, that can effectively assist the functions of plant roots for optimal precision greenhouse, green walling or homegrown crop production of all kinds, without the use of chemical pesticides or fungicides.

In other words, there is provided a continuous bioprocess for vermicompost microbial activity enhancement in an off-ground plant culture system designed for pesticide-free organic precision micro-agriculture, green walling and greenhouse crop production.

### TECHNICAL FIELD OF THE INVENTION

The present invention relates to compositions and methods for biofertilization, biostimulation and bioprotection of cultivated plants.

More particularly, the present invention comprises compositions and methods for effectively improving off-ground plant production and reducing the environmental consequences of salt based fertilizer and chemical pesticide use. Additionally, the compositions and methods of this invention can be used to sustainably manage soil, water and fertilizer use. Additionally, the compositions and methods of this invention can be used to reconstitute soil and mycorhizosphere environments that cultivated plants normally encounter while living in their natural in-ground habitat, as well as promoting vigorous plant growth and development, and to sustainably encourage natural plant resistance to stress, insects and disease, through the strategy of biomimicking natural soil conditions inside of a small container system.

The present invention also relates to agriculture, and more particularly, relates to a high performing, high precision horizontal and vertical off-ground greenhouse and green wall integrated plant growing system and method.

Finally, the present invention also relates to precision micro- agriculture, and more particularly to a high performance horizontal and vertical off-ground greenhouse and homegrown integrated plant growing system and method.

### BACKGROUND OF THE INVENTION

Current technologies for off-ground, soil-less plant production, such as hydroponic agriculture, are well known and widely practiced. As well, a first generation approach for a so-called bioponic agriculture technology in the context of an organic off-ground plant production system using a thin compost phase bioreactor have previously been described in detail in U.S. patent application Publication Ser. No. 14/544,862 filed Feb. 26, 2015, the teachings of which are used herein as reference, and that shares common inventorship with the present invention. The purpose of the present invention is to provide improvements to the aforementioned bioponic plant cultivation method.

Bioprocess is a biotechnology that uses large concentrations of micro-organisms for the purpose of mass production of commercial bioproducts. For instance, the use of bacterial strains of Rhodococcus rhodochorus for the production of protease inhibitor precursors for use in the biopharmaceutical industry, the use of the budding yeast Saccharomyces cerevisiae for the production of beer in the beverage industry, the use of bacterial strains of Xanthomonas campestris for the production of xanthan gum on a commercial scale for use in the food industry, or the use of bacterial strains of Microbacterium laevaniformans for the production of levan on a commercial scale for use in the cosmetics industry, as well as strains of the yeast Kluyveromyces lactis for the production of chymosin (rennet) on a commercial scale for the dairy industry.

Bioprocess technology can be used during either short periods of time for short production cycles (discontinuous bioprocess) or long periods of time (continuous bioprocess) for long production cycles, all depending on the ability of the microorganisms to secrete the desired product, or any other desired result. It is always carried in a special fostering environment in which those microorganisms will indeed find all of the ideal conditions for their optimal growth, development and desired biological activity. The term bioreactor designates such environments.

Large concentrations of microorganisms can also be used in agriculture. Many investigators in the area of soil ecology have discovered a considerable amount of microorganisms to be present in the volume of soil occupied by plant roots, more precisely the thin layer of soil (about 1 to 2 mm thick) surrounding the roots. These microorganisms are thought to have no direct consequence on plant growth and vigour. The shear extent of crop roots in soil suggests that a significant portion of soil is actually within the influence of the root zone (about 5 to 40% of soil in the rooting zone depending upon crop root architecture). This area has been termed as being the rhizosphere. It has been discovered that a few microbial species present in the rhizosphere are either deleterious or beneficial to plant growth. The bacterial species that are beneficial to plant growth and development have been termed Plant Growth Promoting Rhizobacteria, or PGPR.

As well, other soil ecology investigators have discovered that some distinct species of soil molds and yeasts also have plant growth promoting traits. They have been termed Plant Growth Promoting Fungi, or PGPF. Their morphology and mode of action are substantially different from those of yet another group of beneficial fungi called arbuscular mycorrhizae, that have also been proven to be beneficial for plant development.

Taken together, all of those microbial consortia create a very rich and complex ecosystem, or biome, around plant roots. The term mycorhizosphere stands for the volume of soil directly in contact with both roots and fungal filaments, and that is directly influenced by them.

The term mycorhizoplane designates the surface of fungal filaments and their associated plant roots, on which distinct beneficial bacterial populations called PGPR can adhere to create a thin sheath formation called a biofilm. A biofilm is created by a bacterial cell migration process called quorum sensing. The term rhizocompetence designates the ability of some bacterial species to adhere to both mycelial filaments and nourishing plant root hairs. It has been found that the tripartite symbiosis between bacteria, fungi and the nourishing plant roots constitutes the fundamental explanation of soil fertility. The science of PGPR is thus relatively young in comparison to the knowledge and use of nitrogen fixing bacteria. For the moment, its applications to crop production are limitedm but the science is developing rapidly. Growers and the crop production industry are well adviced to keep ahead of its newest developments. Many producers have exploited to great success the use of inoculants containing nitrogen fixing bacteria to limit the need for costly fertilizers in legume crops. As we aim to optimize the performance of all crops, the value of inoculating soil with other microorganisms, or promoting the activity of endogenous residing beneficial microorganisms through sustainable management practices, are being considered worldwide.

As used herein, the acronym PGPR stands for Plant Growth Promoting Rhizobacteria. The acronym PGPF stands for Plant Growth Promoting Fungi. Of those microbial crop growth promoters, PGPR are the most abundant in soil. They can in turn be classified into many groups according to their function in both the rhizosphere and the rhizoplane :
MHB stands for Mycorhization Helper Bacteria
MAB stands for Mycorhizae Associated Bacteria
NFB stands for Nitrogen Fixing Bacteria
PSB stands for Phosphate Solubilizing Bacteria
PDB stands for Polysaccharide Decomposing Bacteria
PHSB stands for Plant Hormone Stimulating Bacteria
PSHB stands for Plant Stress Homeoregulating Bacteria. These include beneficial rhizosphere bacteria with probiotic activity
SCB stands for Substrate Conditioning Bacteria

The term geoponic agriculture stands for traditional full soil (also called in-ground) agriculture. The word off-ground stands for plant culture that is performed outside of a full soil environment. It does indeed appy to container gardening. Plant culture can also be done using soil-less media. The well-known limit of geoponic agriculture using containers is brought by the spiral root formation that usually happens in non-copper coated traditional containers. Prior art teaches of a container for plants in which there is proven nourishing root differentiation in an upper layer of organic compost phase, located in the superior part of the recipient. This plant container is described in U.S. Pat. No. 6,247,269 and U.S. Pat. No. 7,036,273 and shares common inventorship with the present invention. In this type of specialized container, the tap root system is allowed to differentiate in the lower part of the recipient, into the water reservoir. Sandwiched in between those two regions, a buffer zone of air and granular, moist non-soil medium (e.g. such as vermiculite) will naturally allow the creation of these two rhizosphere zones. The presence of numerous, narrow apertures that may be slot-like such as the ones described in detail in U.S. Pat. No. 7,036,273 at the level of the rootforming interface zone, indeed allows the complete development of root tissues, and decreases considerably, if not completely, the spiral root formation that usually happens in non-copper coated traditional pot cultures. In doing so, the need for tedious procedures such as repotting is completely eliminated.

The use of vermicompost is more and more common in horticulture, small scale sustainable organic farming and agriculture. It is a finely divided, peat-like material with high porosity, good aeration, drainage, water holding capacity, microbial activity, excellent nutrient status and buffering capacity, thereby a great contributor to soil fertility. This medium is the product of the composting process using a wide variety of worms, such as red wigglers (Eisenia fetida), tiger worms (Eisenia andrei) white worms and various species of earthworms, such as the European nightcrawler (Eisenia hortensis) and the African nightcrawlers (Eudrilus eugeniae) to create a final mixture of decomposing vegetable or food waste. These species are not the same worms as those that are found in ordinary soil or on pavement after a heavy rain, such as the common earthworm Lumbricus terrestris. It is not recommended for vermicompost production as this species has to burrow deeper than most vermicompost bins can accomodate. The term vermicast applies to worm castings, worm humus and worm manure. It is the end product of the decomposition of highly organic soil by the gut microflora of an earthworm. These mostly aerobic bacteria are of the genus Pseudomonas, Rhizobium, Bacillus, Azospirillum, Azotobacter, Actinomyces, Streptomyces, Paenibacillus, Azoarcus, Burkholderia, Alcaligenes, Sphingomonas and many more. All of this microflora is amplified in worm gut, and contribute to soil ecology and fertility once released in the environment surrounding plant roots. It has been documented that microbial activity in worm castings is 10 to 20 times higher than in the soil or organic matter that the worm ingests. This material has been proven to contain considerable amounts of PGPR bacterial species. These micro-organisms enhance plant health, plant growth and convert nutrients already present in the soil into plant-available forms. They also improve root growth and function, and improve plant physiology directly by production of enzymes, as well as plant growth-regulating hormones such as auxins and gibberellins, and indirectly by controlling plant pathogens, nematodes and other pests. They play a very important role in sustainable agriculture. As well, unlike other compost, worm castings contain worm mucus which helps prevent nutrients from washing away and to hold moisture better than plain soil.

The creation of green walls, also known as living walls or vertical gardens, is a special horticultural feature that partially or completely covers walls with greenery, for purposes of urban agriculture, urban gardening, or for its beauty as art. It is not to be confused with vertical farming. Green walling systems include a special, lightweight growing medium or substrate, such as coco coir, conditioned as mats, or soil. Most green walls also feature an integrated watering system complete with microirrigation devices and water reserves. Green walls may be indoors or outdoors, either freestanding or attached to an existing wall. They can be provided in modular mat type panels for covering a wide variety of wall sizes, as well as using loose media. The green walls using loose media—such as soil—can be either a «soil-on-a-shelf» or a «soil-in-a-bag» type system. Green walls provide insulation to keep a constant temperature inside buildings, and to provide a very effective means of controlling the urban heat island effect, which is heat build-up in cities, also called insolation. Plant surfaces absorb solar radiation and prevent the re-radiation of that heat. It has been documennted that plant surfaces do not rise more than 4-5 degrees Celsius above the ambient, as a result of transpiration. An ideal green walling system using soil should support vibrant root systems of mature plants for many years without reparation or intervention, while adequately allowing water and solubilized nutrients to either drip or wick to reach the roots according to the individual needs of all plants, and encourage the establishment of a healthy soil microflora around the nourishing roots, for optimal results.

However, to date, there has been no attempt to create a comprehensive and integrated off-ground plant growing or green walling system that actually uses a combination of high porosity organic potting soil, arbuscular mycorhizae and vermicompost as a natural, organic controlled microbial substratum being part of a bioreactor technology that would not lead to root congestion and that would lead to plant maturity in a relatively compact container type. The bioprocess it fosters could effectively bring selected microbial populations together in a dynamic consortium expressly using organic, non salt-based fertilizers, for the purpose of sustainable, high performance organic greenhouse food production or high performance container horticulture for amateur gardening enthusiasts. The North American, if not the worldwide market for organic agriculture products is considerable, as the needs for wholesome food production without the use of salt based fertilizers and chemical pesticides keep increasing, and gain more and more consideration for a well aware public. As well, studies have clearly proven the health and environmental dangers of mass production and animal consumption and open field testing of genetically modified organisms (GMO). Public awareness concerning these dangers have prompted the search for more sustainable agriculture models and methods. As well, the concept of food sovereignty is one of the major trends for the future. It stands for the fundamental right of a State to freely choose its own agricultural crops and policies, without interfering or damaging the natural environment, and without any negative consequences on its neighbors, while keeping food product imports from other regions of the world at a minimum.

As well, to date, there has been no attempt to create a low cost, comprehensive and integrated off-ground system that actually uses a combination of potting soil, arbuscular mycorhizae and earthworm compost (vermicompost) as a natural, organic controlled microbial substratum being part of a bioreactor technology that will effectively bring selected microbial populations together in a dynamic consortium expressly using organic and inorganic wastes for the purpose of green walling, water reuse, rain water effluent management and water depollution. This type of vertical or horizontal water depollution system can expressly use organic waste instead of non salt-based plant fertilizers, and selected dwarf varieties of water filtering marsh plants growing in a modular, artificial marsh like infrastructure environment for effective water phytopurification and treatment, and for remediation of poor air quality. On a worldwide scale, the needs for treatment of water waste are considerable, indeed, inexpensive and effective water waste treatment is the first concern in public health.

### SUMMARY OF THE INVENTION

It is an object of the present invention to provide a plant cultivation system wherein plant growth is enhanced by the use of a controlled and selected microbial consortium that is expressly beneficial for plant development and resistance to disease.

It is an object of the present invention to provide a plant cultivation system wherein plant growth is enhanced by the use of a controlled and selected microbial consortium and controlled concentrations and compositions of organic plant fertilizers that are beneficial for plant development and resistance to disease.

It is an object of the present invention to comprise compositions and methods useful in the process of vertical farming and green roof food production.

It is an object of the present invention to comprise compositions and methods useful in the process of green walling.

It is an object of the present invention to comprise compositions and methods useful in the techniques of off-groung organic greenhouse agriculture.

It is an object of the present invention to comprise compositions and methods useful in the creation and maintenance of healthy and clean soil environments for off-ground agriculture.

It is an object of the present invention to comprise compositions and methods useful in improving the qualities of soil.

It is an object of the present invention to comprise compositions and methods useful in controlling odors and turbidity generated by organic fertilizers standing still in a water reserve.

It is a further object of the present invention to provide a plant cultivation method wherein continuous and progressive soil remineralization are allowed for continuous plant growth.

It is a further object of the present invention to provide a plant cultivation method wherein microbial replenishing is allowed for permanent conditioning of soil and water environments for maintenance of perfect plant health.

It is an object of the present invention to provide a plant cultivation system in which root damage is minimized.

It is an object of the present invention to provide a microbial environment that allows selection in favor of plant growth promoting rhizobacteria species that are naturally present in considerable amounts in vermicompost or earthworm casts, and therefore enhance their microbial activity in favor of cultured plants or crops that are produced in an off- ground culture system.

It is also an object of the present invention to provide a water filtration system in which selected marsh plants are grown with a continuous supply of grey or brown water.

It is also an object of the present invention to provide a water filtration system in which selected marsh plants and selected water microbial conditioners are grown with a continuous supply of grey or brown water in a bioreactor environment.

It is therefore an object of the present invention to provide a comprehensive organic growing system where probiotic mycorhizosphere bioengineering strategies effectively bring a solution to polluted water treatment and improve plant growth and plant productivity.

According to one aspect of the present invention, there is provided a plant growing system comprising a reciever having a bottom wall and a side wall extending upwardly therefrom, either a single or a series of soil support inserts placed on a side by side relationship and spaced from the bottom wall to define a space between the bottom wall and the soil support insert, at least one wall extending downwardly from the soil support member to define a cavity, a few large apertures in the downwardly extending wall of said cavity, water at the bottom of the plant container, an air space between the upper surface of the water and the soil support member, a non-soil medium within the cavity, said non-soil root growth promoting medium being an exclusive hydrophilic, fibrous mineral-based geotextile material with effective wicking properties, such as the one described later in this document, and a thin layer of high porosity soil on top of the geotextile wicking medium.

According to a further aspect of the present invention, there is provided a plant cultivation method comprising the steps of supplying a plant cultivation system comprising a reciever having a bottom wall and a side wall extending upwardly therefrom, a series of soil support inserts placed on a side by side relationship and spaced from the bottom wall to define a space between the bottom wall and the soil support insert, at least one wall extending downwardly from the soil support member to define a cavity, a few large apertures in the downwardly extending wall, water at the bottom of the plant container, an air space between the upper surface of the water and the soil support member, a non-soil wicking medium within the cavity, said non-soil wicking medium being a hydrophilic, fibrous mineral wicking geotextile material such as the one described later in this document, and a thin layer of high porosity soil on top of the non soil wicking medium.

According to one aspect of the present invention, there is provided a plant cultivation system comprising a single or a plurality of cassette inserts that contain a thin layer of high porosity organic compost for the creation of an aerobic soil environment that will favorably select for nonfermentive bacterial species.

According to one aspect of the present invention, there is provided a plant cultivation system comprising a series of recievers placed directly on the ground for the successful cultivation of tall plant specimens that require enough room to grow.

According to one aspect of the present invention, there is provided a plant cultivation system comprising a series of recievers, a tank for containing water, a pump for allowing movement of water in the bottom of said recievers, a dripping system for allowing plants to get watered directly at the base, timers, solenoid valves and proportional fertilizer injectors as part of a complete robotized organic greenhouse infrastructure.

According to one aspect of the present invention, there is provided a probiotic approach to mycorhizosphere engineering and to the biological bioprocess at work in the abovementioned embodiments, including the use of vermicompost. Probiotic strategies should be chosen and used during plant production. Probiotics is a strategy designed to keep natural soil defences against plant pathogens and soil diseases, therefore reducing the use of chemical pesticides.

Therefore, the bioprocess at work in the present invention can be enhanced by the addition of microorganisms that are involved in probiotics for effective control of plant pathogens and root diseases. They include microorganisms that produce minute amounts of antibiotics, microorganisms that secrete siderophores for antibiosis against pathogens, endophytes for prevention of spreading infections, microorganisms that are involved in biochemical plant defence metabolical pathways such as Induced Systemic Resistance and Systemic Acquired Resistance.

According to one aspect of the present invention, there is provided an electronic monitoring system that allows the grower to be informed concerning the status of any plant growing parameter of his own choice in the rhizosphere environment and thus allowing the grower to perform any desired intervention according to the changing needs of his plants.

According to one aspect of the present invention, the bioprocess at work in the present invention should happen in at least six precise steps, in an orderly fashion both in time and in space instead of at random, to ensure robust plant health, and the choice of micro-organisms should be done accordingly.

The designated microbial species should be viewed as suggested examples.

The first step of the bioprocess is vermicompost enrichment of the thin layer of high porosity substratum.

The second step of the bioprocess is mycorrhizal inoculation (Glomus irregulare, Glomus mossae, Glomus etunicatum, Glomus fasciculatum spp)

The third step of the bioprocess is the proactive opportunistic rhizosphere colonization occurring at the same time as PGPR biofilm elaboration. Rhizosphere and mycorhizosphere colonization is done through distinct species of Mycorrhizae Associated Bacteria. They are known to be fungus-specific but not plant-specific. (Bacillus pumilus, Bacillus subtilis). Once the early colonizers are installed, they can recruit PGPR species already inoculated through prior vermicompost addition and that are waiting for encouragement to establish themselves on the rhizoplane through biofilm formation.

The fourth step of the bioprocess is appropriate biofilm nutrition by some distinct PGPF species (Saccharomyces cerevisiae, Pichia pastoris, Yarrowia lipolytica)

The fifth step of the bioprocess is compost phase conditioning by distinct SCB species, especially lactic bacteria (Lactobacillus casei, Bacillus coagulans, Lactobacillus acidophilus, Lactobacillus plantarum, Streptomyces lactis)

The sixth step of the bioprocess is complete organic matter decomposition and optimal nutrient bioavailability by distinct PDB species (Rhodobacter capsulatus) and fungi (Trichoderma harzianum).

The seventh step of the bioprocess is plant protection against pathogens by distinct PSHB species (Streptomyces griseus, Streptomyces fulvus, Enterobacter agglomerans).

According to one aspect of the present invention, a specific word should be coined for designating this bioprocess. The word bioponic comes from the old Greek words bios, for life, and ponos, for work.

It is a very different plant culture approach than hydroponics, in which the work is performed through the actions and properties of water. In the case of bioponic agriculture, the myriads of life forms found in the system indeed contribute considerably to the work effort for plant growing. It also applies to the area of water purification, where the combined actions of plants and selected microorganisms contribute together in the effort of bioremediation of water waste. In other words and more particularly, bioponic agriculture is a specialized version of hydro-organic agriculture.

It is an object of the present invention to avoid water and fertilizer waste. Bioponic agriculture allows the use of all of the water, microbial conditioners and organic fertilizer inputs. It is important to notice that in all cases of hydroponic culture, the water and the mineral salts it contains have to be discarted once plants have been harvested, a method known as being a pump-and-dump approach to water management, which contributes to water and fertilizer waste.

### DETAILED DESCRIPTION OF THE INVENTION

The present invention comprises compositions and methods for bioprotection, biostimulation, biofertilization, and maintenance of healthy soil ecosystems for off-ground organic greenhouse agriculture.

The off-ground plant culture recipient used in organic greenhouse agriculture has to be concieved in order to prevent the spiral root formation that usually happens in non-copper coated traditional containers for plants. Prior art teaches of a container for plants in which there is proven nourishing root differentiation in an upper layer of organic compost phase, located in the superior part of the recipient, and a so-called radication interface to prevent root congestion and overcrowding. This plant container is described in U.S. Pat. No. 6,247269 and U.S. Pat. No. 7,036,273 and shares common inventorship with the present invention, the teachings thereof being incorporated by reference.

As far as microbial compositions are concerned, they may comprise a mixture of microorganisms, comprising arbuscular mycorrhizae, bacteria, fungi, algae, protozoa, bacterial endophytes, fungal endophytes, and/or indigenous or exogenous microorganisms, all of which form a distinct and functioning micro-ecosystem with distinct roles for its various members.

Composition and methods of the present invention may act individually or synergistically in order to promote plant growth. The synergic action happens as part of a structured bioprocess in both space and time, and not at random. For example, in a composition of the present invention, one group of microorganisms may enhance the contact surface area between the plant roots and the soil substratum, a second group of microorganisms can establish itself on the root system as preemptive, opportunistic colonizer in order to constitute a protective biofilm covering the root surface, said preemptive colonizers subsequently encouraging the recruiting and permanent establishment of a third group of microbes such as PGPR that will promote more root and shoot growth, hence more establishment of more beneficial microorganisms through recruitment or quorum sensing through a circadian cycle mechanism, a fourth group of microorganisms can participate in the feeding and the biostimulation of the plant roots and their associated microbial consortia, while the fifth group of microorganisms can regulate the physico-chemical parameters of the soil environment, another group of microorganisms with an extensive metabolic repertoire may decompose organic molecules and oxidize toxic degradation products, while another will effectively promote optimal soil ecology by keeping natural soil defenses against undesirable microbial invaders such as plant pathogens or root diseases. As well, micro-organisms may consume specific substances in the soil environment and produce metabolic compounds that act as nutrients for other microorganisms, thus creation a sustainable microbiome for keeping perfect health of both microbial and plant life over a long term period in the plant culture system.

Compositions of the present invention may provide microorganisms that produce bioactive compounds or biological agents including, but not limited to phytohormones, cytokines, antibiotics or siderophores.

Compositions of the present invention comprise at least one micro-organism that belong to specific microbial groups: Arbuscular mycorrhizae; early opportunistic preemptive root colonizers such as Mycorrhizae Associated Bacteria (MAB) and Mycorrhization Helper Bacteria (MHB); selectively recruited beneficial plant growth promoters found in vermicompost, such as Plant Growth Promoting Rhizobacteria (PGPR) and bacterial plant endophytes ; selected PGPF such as intraspecific variants of yeasts for proper biofilm stimulation and nourishment ; lactic bacterial populations for constant soil conditioning, such as Aerobic Endospore Forming Bacteria (AEFB) or Substrate Conditioning Bacteria (SCB) ; and active decomposers of complex organic matter, such as Purple Non- Sulphur Bacteria, and Plant Stress Homeoregulating Bacteria as natural plant disease resistance inducers.

According to one aspect of the present invention, the bioprocess at work in the present invention should happen in at least seven precise steps, progressing in an orderly manner both in time and in space instead of at random, and the choice of micro-organisms should be done accordingly. The designated microbial species should be viewed as suggested examples.

The first step of the bioprocess is vermicompost enrichment of the thin layer of soil phase contained in the bioreactor. This procedure constitutes the most natural and effective strategy to allow PGPR enrichment of the soil phase by distinct species of plant growth promoting bacteria and also the most effective strategy to allow the conception of a simpler, safer, and less expensive bacterial inoculum to be applied later on during the bioprocess. The present invention comprises compositions that include at least one species of PGPR bacteria that are known to adhere to the rhizoplane (Pseudomonas fluorescens, Pseudomonas aeruginosa, Pseudomonas putida, Paenibacillus polymyxa, Azospirillum brasilense, Arthrobacter spp,) and at least one species of beneficial bacterial endophytes (Pseudomonas, Bacillus, Enterobacter, Agrobacterium, Burkholderia).

Endophytes are non-pathogenic microorganisms that are adapted for specifically living inside of plant tissues such as plant roots and shoots without doing harm and gaining benefit other than securing residency. Some are internal colonists with apparently neutral behavior, others are symbionts. The latter are known to actively reduce stresses and assist plant growth, health and defense. In general, endophytic bacteria originate from epiphytic bacterial communities of the rhizosphere and phyllophane, as well as endophyte-infected seeds, soil substrate or other planting materials.

They enter plant tissues either through wounds due to insect or nematode damage, through natural openings in root hairs, at the base of lateral roots, or by secreting powerful lytic enzymes such as cellulase and pectinase to locally damage the root cuticle at the point of entry. The capacity of these helpful bacteria and fungi to colonize internal plant tissues could confer a selective or an ecological advantage over those that stay on the root or plant surface, because the internal tissues of plants provide a more protective and uniform living environment. It has been shown that PGPR and endophyte recruitment starts at the level of the rhizoplane, because of the proven continuum of root-associated microorganisms from the rhizosphere to the rhizoplane to the root epidermis to the cortex and the shoot itself. An effective inoculum should contain endophyte microbial species and strains with high rhizocompetence.

Plant Growth Promoting Rhizobacteria (PGPR) can act in many different ways, and can be classified into many groups according to their function in the rhizosphere and rhizoplane :
MHB stands for Mycorhization Helper Bacteria
MAB stands for Mycorhizae Associated Bacteria
NFB stands for Nitrogen Fixing Bacteria
PHSB stands for Plant Hormone Stimulating Bacteria
PSB stands for Phosphate Solubilizing Bacteria 0

PSHB stands for Plant Stress Homeoregulating Bacteria. These include
beneficial rhizosphere bacteria with probiotic activity.

To be considered as a PGPR, a bacterial species has to fulfill 2 out of these 3 conditions :
1. Active colonization of the rhizoplane
2. Proven plant growth stimulation
3. Phytopathogen biocontrol abilities

PGPR that have a biofertilizer activity are available for increasing crop nutrient uptake of nitrogen from nitrogen fixing bacteria associated with roots (Azospirillium), iron uptake from siderophore producing bacteria (Pseudomonas), sulfur uptake from sulfur-oxidizing bacteria (Thiobacillus), and phosphorus uptake from phosphate-mineral solubilizing bacteria (Bacillus, Pseudomonas).

Some PGPR species also have a biostimulant activity. For instance, species of Pseudomonas and Bacillus can produce phytohormones or growth regulators that cause crops to have greater amounts of fine roots which have the effect of increasing the absorptive surface of plant roots for uptake of water and nutrients and higher mycorrhization density. These PGPR are referred to as biostimulants and the phytohormones they produce include indole-acetic acid, indole-butyric acid, cytokinins, gibberellins, nitrous oxide and inhibitors of ethylene production.

The second step of the bioprocess is mycorrhizal inoculation by arbuscular mycorrhizae (Glomus irregulare, Glomus mossae, Glomus etunicatum, Glomus fasciculatum spp). The present invention comprises compositions that include at least one species of mycorrhizae. They provide nutrition, secrete enzymes and provide a very elaborated filamentous network in the soil called a mycelium, increase the contact surface between soil and plant root tissues, and increase the ability of the various bacterial species to colonize the rhizosphere. The mycorrhizal mycelium attracts specific types of bacteria, called Mycorrhization Helper Bacteria, and Mycorhizae Associated Bacteria that complete the symbiosis association and cooperate together for the proper nutrition and mutualistic symbiosis between the plant and the fungus.

Mycorrhizal fungi are known universal symbionts living in close association with the majority of terrestrial plants. Ectomycorrhizal fungi are strictly aerobic, and are associated to most evergreen and deciduous trees. Ericoid mycorrhizae are associated with Ericaceae plants that live in acidic soil environments, such as cranberries and blueberries. Arbuscular mycorrhizae are associated with herbaceous plants as well as numerous deciduous shrubs and fruit trees, which make up more than 80% of the flora and include most of the cultivated crops. Mycorrhizae are obligate symbionts and cannot survive without living in close association with plants. They are the microorganism of first choice for initiating the steps of a continuous bioprocess in a perfectly aerobic, nonfermentative bioreactor system designed to improve plant yields. The network of filaments they create in soil provide the necessary attachment support for mycorhizocompetent beneficial bacterial populations. Mycorhizae can improve plant yields by a better supply of mineral nutrients, increase the production of flowers, protect the roots against phytopathogens, reduce transplantation shock due to an improved water supply, increase resistance to drought, promote early vegetable growth, induce a better firmness in plant tissues, which contribute to extend the period of cold storage, increase the survival rate to winter frosts and contribute to stabilize soil particles. With their extensive filament network, mycorrhizal fungi dramatically increase the area of root absorption in the soil much more than that of feeder roots and hairs. As well, mycorrhizae are strict aerobes that live very well in a thin soil layer of high porosity compost such as the one that characterize the bioreactor design herewithin.

The third step of the bioprocess is peemptive rhizosphere colonization by distinct species of Mycorrhizae Associated Bacteria, immediately and naturally followed by PGPR recruitment. The present invention comprises compositions that include at least one species of Mycorrhizae Associated Bacteria and at least one species of Mycorrhization Helper Bacteria. They are known to be fungus-specific but not plant-specific. (Bacillus pumilus, Bacillus subtilis, Pseudomonas fluorescens, Pseudomonas putida) They actively colonize the rhizoplane and include mycorhizocompetent bacterial strains that provide preemptive opportunistic colonization. Preemptive colonization helps to prevent infection of newly formed root tissue by undesireable microorganisms or pathogens because MAB have the advantage of being at the root site first. They also form bacterial biofilms on the surface of the roots for further protection. MAB and MHB colonize the rhizoplane using plant root exudates as nutrients. This colonization has a probiotic action in that it can spatially exclude potential pathogenic bacteria and fungi. They also can solubilise phosphorous, stimulate root growth, secrete growth metabolites, chelate minerals for better uptake and also secrete natural mucilage in the form of a biofilm that improves soil structure through aggregate formation. Once the preemptive colonizers are installed on the rhizoplane, the PGPR species found in vermicompost will be naturally attracted through chemotaxis and encouraged to establish themselves on the mycorrhizal and root surface, in order to elaborate a biofilm and complete the tripartite symbiotic relationship between the plant, the mycorrhizae and the bacteria.

The fourth step of the bioprocess is sustainable biofilm nutrition by distinct, selected beneficial microorganisms, especially PGPF yeasts. The present invention comprises compositions that include at least one species of PGPF. (Saccharomyces cerevisiae, Pichia pastoris, Aureobasidium pullulans, Yarrowia lipolytica, Metchnikowia fructicola, Cryptococcus albidus). Microorganisms that are specialized for doing this live freely in the rhizosphere, and unlike biofilm-dwelling PGPR bacteria, they do not require the presence of a physical support for growing and proliferating. They contain considerable starch reserves, and upon presence of soil microorganisms, interact positively with them and allow the progressive release of glucose through the gradual breakdown of their starch reserves. They also interact favorably with certain bacterial species living freely in the compost phase, conferring them a selective advantage. They also can supply plants with growth factors and stimulants. The latter stimulates a molecular response in plant cells which facilitates the synthesis of natural phytohormones that are responsible for excellent plant growth. Yeasts with PGPF activity also play a role in the bioprotection of cultures against phytopathogens, in that they effectively compete against undesireable fungi for nutrition, bacterial companionship and space. As well, one should not forget about the proven plant growth promoting effects and probiotic effects of a considerable number of organic compounds contained in yeast extracts. Those are released upon the mortality of yeast cells in the soil.

The fifth step of the bioprocess is compost phase conditioning by distinct species of SCB, including either lactic bacteria (Lactobacillus casei, Lactobacillus acidophilus, Streptococcus lactis, Streptococcus agalactiae, Leuconostoc fallax) or members of the Firmicutes (Bacillus coagulans, Bacillus racemilacticus). The present invention comprises compositions that include at least one species of soil conditioning bacteria. This step happens in the rhizosphere, not on the rhizoplane, and the soil environment is conditioned with minute amounts of lactic acid conferring a permanent, slightly acidic pH that creates a premium microbial environment that selects in favor of beneficial PGPR and PDB microbial species. The bioprotection against pathogenic invaders is thus guaranteed, and some bacterial species can also play a role in bioremediation by scavenging and metabolizing toxic metabolic putrefaction by-products suchg as hydrogen sulfide, carbon dioxide, methane gas and ammonia. They also can be considered as SCB species as well.

The sixth step of the bioprocess is complete organic matter decomposition by purple non-sulphur bacteria and by distinct species of both bacterial decomposers that are part of the PDB group (Streptomyces spp, Rhodobacter capsulatus), and fungal decomposers that are found in vermicompost. (Trichoderma harzianum, and molds of all kinds). The present invention comprises compositions that include at least one bacterial species of active decomposers and at least one fungal species of active decomposers. Their role is to assist the work of endogenous decomposers that are already present in soil or compost, such as Actinomyces spp and methanogens, in a pH zone that is maintained stable by the actions of selected SCB species. This step happens at the level of the rhizosphere, and its purpose is to allow the various elements found in the soil ecosystem to dissociate themselves from their organic molecular constituents and complete their respective natural cycle into their transformation as plant nutrients, a process called nutrient biogeochemical cycling. These microbial agents can be classified in the PDB group. The present invention also comprises compositions that may include a special group of PDB called purple bacteria (Rhodobacter sphaericus, Rhodobacter capsulatus, Rhodopseudomonas palustris). They are excellent soil conditioners and decomposers, because of their extensive metabolic repertoire and their ability to metabolize large amounts of sulphur containing contaminants, ammonia and methane gas that might be generated through the process of putrefaction. Uncontrolled putrefaction of organic fertilizers may lead to root morbidity and mortality because of their toxicity, and selected bacterial species can prevent overaccumulation of toxic degradation by-products.

The seventh step of the bioprocess is probiotic disease protection. The present invention comprises compositions that may also include at least one distinct species of probiotic microorganisms for the purpose of protection of low resistance crops to various plant pathogens. These are calles Plant Stress Homeoregulating Bacteria, or PSHB. Bacteria of the PSHB group that are active in slightly acidic soil environments maintained as such by lactic acid bacteria can be added as an additional step for probiotic and bioprotection purposes. Bioprotection inoculants deliver biological control agents of plant disease. Those are organisms capable of slowing the growth or even eradicating other organisms that might be pathogenic or causing disease to crops. Bacteria in the genera Bacillus, Streptomyces, Pseudomonas, Burkholderia, Plantaoe and Agrobacterium are the biological control agents of first choice. They suppress plant disease through at least one of these 3 mechanisms : induction of systemic resistance, production of siderophores or production of antibiotics.

Exposure to the PSHB triggers a defense response by the crop as if attacked by pathogenic organisms. The crop is thus armed and prepared to mount a successful defense against eventual challenge by a pathogenic organism.

Production of siderophores by some PSHB can scavenge heavy metal micronutrients in the rhizsophere (e.g. iron) thus starving pathogenic organisms from complete nutrition that could allow them to mount an attack against crops. Plants seem nonetheless able to still acquire adequate micro-nutrient supply in the presence of these PSHB.

Antibiotic producing PSHB release compounds that prevent the growth of pathogens or competitors.

It has been discovered that vermicompost contains considerable amounts of bacteria that are included in the PSHB group, thus allowing strategies in the area of sustainable organic agriculture that are pesticide free.

The French word terroir designates a given rural region that is characterized according to its ancestral or traditional agricultural or agri- food productions. Terroir biodesign engineering is an area of biotechnology in which specific strains of soil micro-organisms can be put together to expressly and intently recreate traditional natural habitat cultivated soil environments for proper crop biostimulation and biofertilization.

In one aspect of the invention, all of those microbial populations should be added gradually in time, in order to act in specific locations in the soil ecosystem and achieve the purpose of either mycorhizosphere bioengineering or terroir biodesign. The said microbial populations should be replenished on a regular weekly basis, in order to reach a large, effective biomass, as the specific needs of the plants should increase. The constant replenishing of the microfloral populations through microirrigation at the surface of the soil substratum will allow permanent selection of the most rhizocompetent microbial strains. This is especially useful when specific bacterial populations have to be maintained in permanence for the re- creation of natural soil microbial populations that plants encounter in their natural habitat. For instance, the natural soil habitat of tomatoes is especially rich in various Burkholderia species that can be maintained permanently in the greenhouse soil ecosystem through regular replenishings.

The term biofertilization refers to the ability of certain microbial populations to actively feed the nourishing roots of plants. Such populations include symbiotic nitrogen fixing bacteria (NFB) such as Rhizobium, and non-symbiotic nitrogen fixing bacteria such as Azospirillum brasilense or Azotobacter. They also include phosphorus-solubilizing micro-organisms (PSB), such a fungal phosphate solubilizers like vesicular arbuscular mycorrhizae, soil moulds like Aspergillus, or enterobacteria like Serratia marcescens.

The term biostimulation refers to a group of bacteria that are known to synthesize plant hormones such as auxins, gibberellic acids and cytokines that play an important role in plant development. As well, some bacterial populations also interfere with the biosynthesis of ethylene, which stimulates flowering but inhibits root formation. Nitrous oxide (NO) is also a plant hormone whose amounts can be regulated by beneficial bacteria. Those bacteria are grouped under the denomination PHSB, for Plant Hormone Stimulating Bacteria.

The term bioprotection refers to a group of microorganisms that stimulate the natural plant defense mechanisms when in presence of fungal or bacterial invaders. They include members of the group of PSHB (Plant Stress Homeoregulating Bacteria). As well, a few fungal and bacterial species have a nematicide action. Bacteria that condition the soil by the secretion of antibiotics, hydrogen peroxide, lactic acid or larvicides can also be used as bioprotectants. The secretion of lactic acid inhibits the growth of harmful bacteria.

The compositions of the present invention comprise a combination of microorganisms that have proven biofertilization, biostimulation and bioprotection properties. Taken together, they have a positive influence on plant growth and agricultural yields.

The plant culture system of the present invention should include all of the necessary infrastructures for automatically providing water, light, fertilizers and microbial inocula at any desired time. It includes the presence of timers, solenoid valves, proportional fertilizer injectors, water pumps, water tanks, filters, check valves, dripping irrigation lines and strong, steel supporting stand structures for appropriate stability of the recievers, in the case of vertical agriculture installations or green wall installations.

In the case of a green wall installation, a special feature combining the advantages of using high porosity potting soil supplemented with vermicompost in both a «soil-on-a-shelf» and a «soil-in-a-bag» type system is provided. A «soil-on-a-shelf» type system consists of loose growth medium packed into a shelf which is then put onto a wall. A «soil-in-a-bag» type consists of loose growth medium packed into individual bags and then supported by the wall. The selection of loose growth media has grown immensely within the past 5 years. It includes potting soil, peat moss, kenaf palm fibers, coco coir, hydro stone, volcanic lava stone, bark, sphagnum moss, thermoexpanded clay beads, and various proprietary hydroponics media. The new green walling concept described herein consists of modular recievers placed on a side-by-side relationship and joined together to share a common water reserve. This concept is not presently offered by green wall conceptors and manufacturers. The recievers can contain cassette inserts placed at perfect 45 degree angles, and those individual cassette inserts hold planting medium made of a mixture of potting soil, arbuscular mycorhizae and vermicompost, in which plant roots are encouraged to grow and differentiate into their nutrient absorbing and water absorbing functions. This novel and distinctive approach to green walling can be called of a «soil-in-an-insert» type, and allow optimal plant growth and development, easier green wall management by direct intervention on each cassette insert, e.g. in the case of individual plant replacement, without disturbing the neighboring plant specimens. Water, nutrients and beneficial microflora delivery can be ensured by a dripping microirrigation device that brings water directly at the base of every individual plant, ensuring complete success.

An important aspect of the invention resides in the fact that water has to be found in permanence, to encourage root growth through the apertures of the inserts, the so-called apertures being wide and large, while still retaining the root growth promoting mineral geotextile interface wicking material, for optimal soil moisture conservation, which overall will foster optimal microbial welfare and optimal plant development. Hence, it will encourage the continuous probiotic bioprocess in the aerobic bioreactor assembly, which is based on the action of microorganisms that naturally require their high porosity soil environment to be kept moist at all times. This in turn will further encourage root and shoot growth as part of a vertuous cycle. In parallel with the conditioned water reserve found at the bottom of the system for permanent hydration of the tap root system of plants, an entirely robotized watering system can be provided for providing automatic and reliable fertilizer and bacterial conditioners to each individual plant specimen. This should be done through dripping irrigation strategies on the top part of the individual cassette inserts, directly on the compost phase at the base of the plants, for providing fertilizers and microorganisms to the superficial (nourishing) root system conveniently found in the proximity of said dripping irrigation device.

In the case of a greenhouse installation, a green wall infrastructure as well as in the case of an individual plant container, it is also an object of the present invention to provide a means of monitoring and supervising the physico-chemical parameters and characteristics of the three different rhizosphere zones found in the plant culture system with a special removable or replaceable vertical plastic strip, or any kind of sliding device, that acts as both as a multisensor and as a radio transmitter that can be easily added to the entire concept. Many kinds of miniaturized sensors are presently available on the market place for detecting environmental parameters in various media, such as soil, soft water or sea water. These include hygrometric sensors for precise sensing of humidity levels, thermocouples for precise sensing of temperature, oxygen sensors, carbon dioxide sensors, conductivity sensors for precise sensing of ionic concentrations in the soil or water, ammonia sensors for precise and just-in- time detection of putrefaction by-products, and the like. What is suggested here is a variety of miniaturized, specialized high precision sensors placed along a plastic strip that can be inserted throughout the three rhizosphere zones (water reserve-interface-soil) thus allowing exposure to the different parameters that are found in either of these three rhizosphere zones. The sensors can be physically coupled to electronic captors and electronic transmitters on the surface of the strip with corrosion-proof electrical wire, such captors and transmittors will allow wireless communication between the strip device to an electronic control panel that can be placed nearby, such as those used in domotics. The electronic control panel can thus communicate with the monitoring strip, and send all information to any intelligent cell phone, tablet computer or personal computer through wifi signals. This will allow constant monitoring of any desired parameters by the user through the use of mobile applications, which is the ideal system for gardeners, landscapers and greenhouse producers alike. As well, any kind of artificial intelligence program can be designed in order to allow automatic waterings, automatic fertilization or automatic microbial soil conditioning to the plants through the irrigation system that is coupled with the bioponic greenhouse production infrastructure, thus allowing the creation and maintenance of very precise plant growing parameters, according to the needs of any cultivated plant. This kind of precision agriculture is expressly designed to improve greenhouse supervision and individual container utilization by all gardeners, beginners and professional alike, for optimal results.

### BRIEF DESCRIPTION OF THE DRAWINGS

FIG. 1 shows a perspective view of a trough-like receiver and cassette insert placed inside on a side by side relationship;

FIG. 2 shows a perspective view of a series of troughs placed on a large horizontal surface inside of a greenhouse installation

FIG. 3 shows a longitudinal section of cassette insert inside trough-like receiver;

FIG. 4 shows the step of vermicompost enrichment of bioreactor environment

FIG. 5 shows the step of mycorhizal inoculation in bioreactor environment;

FIG. 6 shows the step of mycorhizal germination in bioreactor environment;

FIG. 7 shows the step of mutual mycorhizal and root growth in bioreactor environment;

FIG. 8 shows the step of mycorhizal infection of root tissues in bioreactor environment;

FIG. 9 shows the step of mycorhizal colonization of root with MHA and MHB preemptive colonizer species in bioreactor environment;

FIG. 10 shows the step of PGPR and bacterial endophyte and fungal endophyte recruitment by MHA and MHB preemptive colonizers in bioreactor environment;

FIG. 11 shows the step of PGPF nourishing action on colonized roots and on SCB lactic acid producing bacterial populations in bioreactor environment

FIG. 12 shows the step of SCB soil conditioning, especially lactic acid producing bacterial populations in bioreactor environment;

FIG. 13 shows the step of PDB controlled decomposing action in bioreactor environment;

FIG. 14 shows the step of PSHB probiotic action in bioreactor environment

FIG. 15 shows a diagram illustrating the successive addition of microbial species in bioreactor environment;

FIG. 16 shows a perspective view of individual container unit complete with electronic monitoring vertical stripe inserted through the three rhizosphere zones.

FIG. 17 shows two aspects of a new type of interface structure and design. FIG. 17a shows an interface support element made of a small plurality of downwardly extending ribs from the horizontal separation plate. FIG. 17b shows the same structure being filled with a special geotextile material that acts as a wick for allowing capillary transfer of water from water reserve to soil compartment, while allowing any size of root to pass therethrough.

FIG. 18 shows an aspect of a green walling modular unit.

### DESCRIPTION OF THE PREFERRED EMBODIMENTS

The aim to allow spatial segregation and functional differentiation of the three main rhizosphere zones according to their respective nutrient and water absorbing functions has been met with the creation and development of the original culture recipient and method described in U.S. Pat. No. 6,247,269 B1 that shares common inventorship with the present invention, the teachings thereof being incorporated by reference.

Hence, the nourishing roots will be properly and appropriately differentiated in a thin layer of high porosity organic compost phase, located in the superior half of the recipient. The tap roots will be differentiated and located in the lower half of the recipient, directly into the water reservoir. Sandwiched in between those two regions, a buffer zone of air and moist non-soil medium will naturally allow root differentiation and the trophic cascade it naturally generates, as demonstrated by experimental data.

The presence of numerous large apertures at the level of the rootforming interface zone indeed allows the complete development of healthy root tissues, and decreases considerably, if not completely, the spiral root formation that usually happens in non-copper coated traditional pot cultures. In doing so, the procedure of repotting is completely eliminated, and plant growth is substantially encouraged and improved.

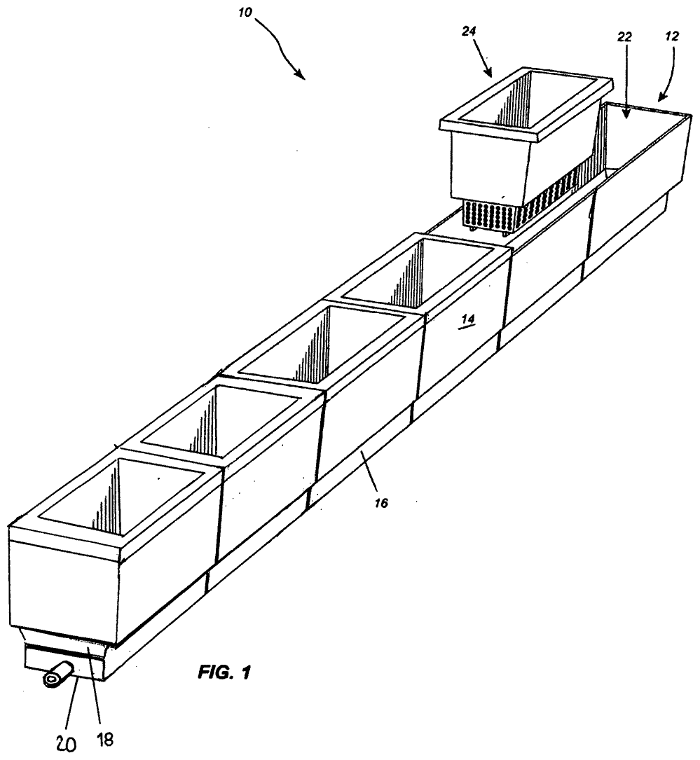

Turning to the arrangement shown in FIG. 1, there is illustrated a plant growth system 10 which is similar to that shown in prior art U.S. Pat. No. 6,247,269 B1 and U.S. Pat. No. 7,038,273 B2, which shares common inventorship with the present invention and which are incorporated herein by reference. Accordingly, only a portion of the container system is illustrated herein.

As shown in FIG. 1, there is provided a plant growth system 10 which includes an outer container generally designed by reference numeral 12, The outer container 12 has an upper side wall 14 and a lower side wall 16 which are joined together by merging section 18. There is also provided a bottom wall 20. The said container has a considerably elongated form, to create a trough like recipient 22. A plurality of short containers that are joined together to create a large water reserve can also be considered. There is also provided at least one inner insert element 24 of the type illustratedin U.S. Pat. No. 6,247,269 B1, with a few modifications, as will be described herein. The inserts are placed along a straight line on a side by side relationship inside the trough like receiver. Another embodiment of the invention is a plurality of individual containers, each one with its own individual insert, that can be joined together on a side by side relationship.

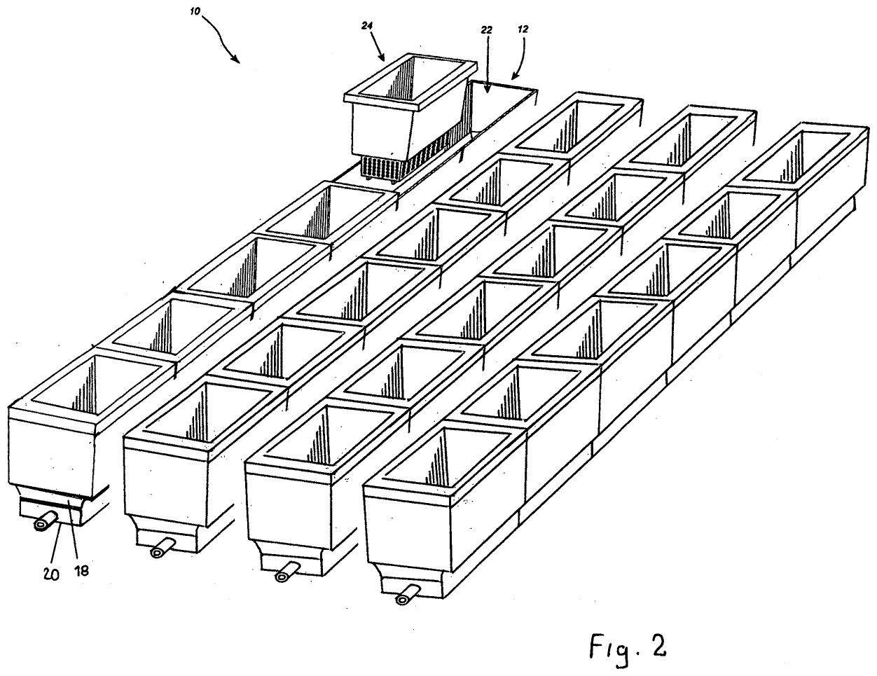

Referring to FIG. 2, a plurality of trough-like containers, or a plurality of individual gardening modules, can be placed in parallel rows in order to cover a large indoor or outdoor surface, for urban farming or greenhouse plant culture, respectively.

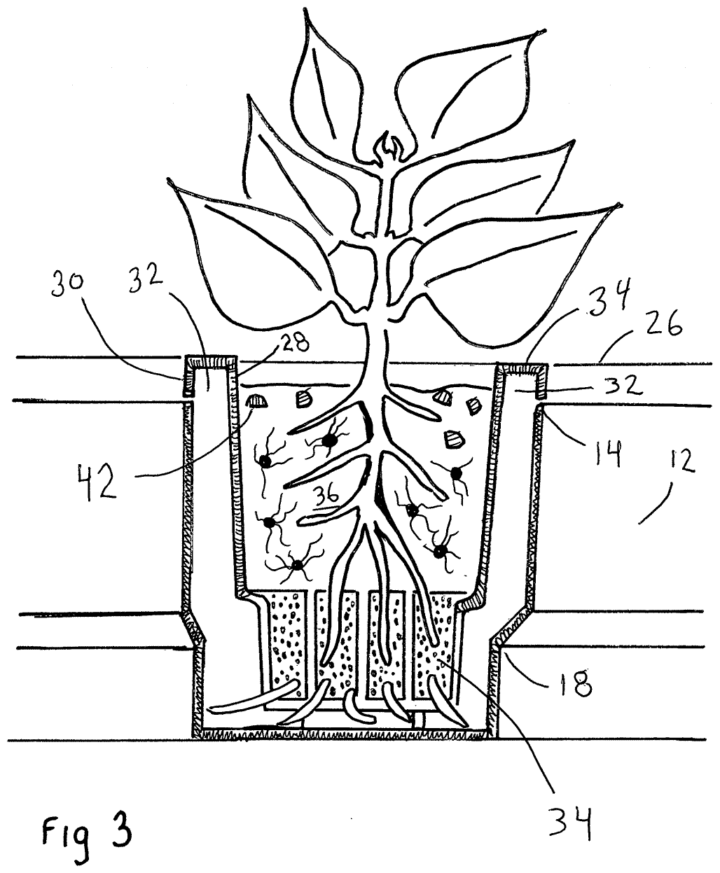

Referring to FIG. 3, an inner insert 26 has an upper inner side wall 28 and an upper outer side wall 30 which defines an air space 32 therebetween. Apertures 34 are provided in the merging section between upper inner side wall 28 and upper outer side wall 30. As may be seen, inner insert 26 seals on both the upper marginal edge of upper side wall 14 and on merging section 18 of outer container 12.

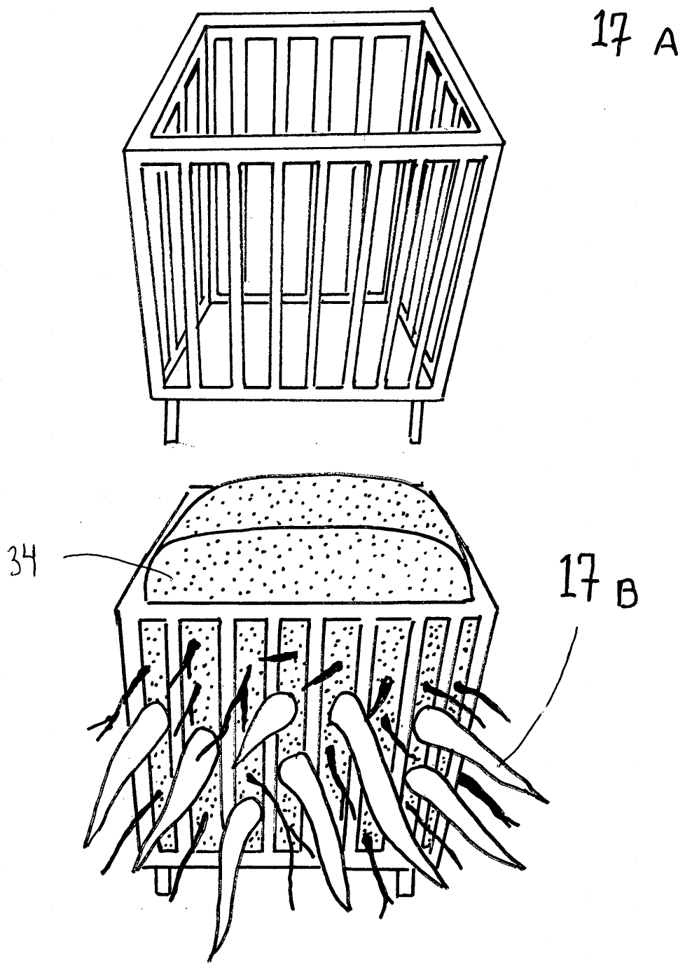

As described in aforementioned US Patent, there are provided inner cavities defined by inner cavity walls 32 which are formed in a manner similar to that described in the patent and the embodiment of FIG. 17, i.e. a reduced plurality of apertures. As shown in FIG. 3, the inner insert 26 has a lower portion thereof filled with an inert, hydrophilic, root-friendly growing medium such as mineral geotextile wicking material 34 while on too thereof there is supplied a conventional high porosity organic potting soil 36. In the bottom of container 12 there is provided water which is at level so as to allow for the creation of an air space.

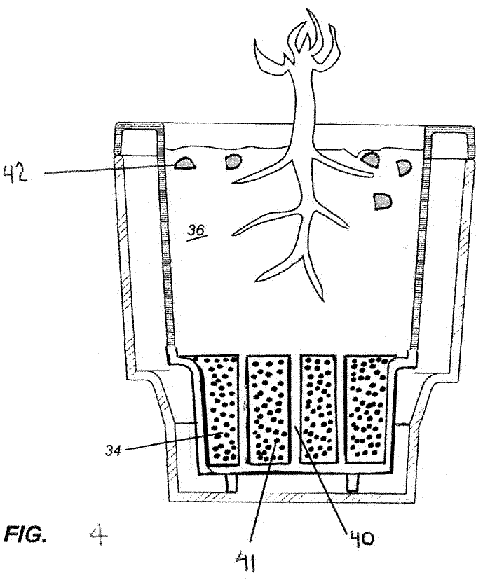

In a preferred embodiment of the invention, shown in FIG. 4, there is provided a basket structure made of a small plurality of vertically projecting ribs 40 from the horizontal separation plate, and concieved for holding a brick 34, said brick being preferably made of geotextile that is not biodegradable, inert, compliant, non-toxic, and highly hydrophilic loose mesh material. This innovative design is concieved in order to act as a wick that will allow capillary uptake of water from the water reserve, which will attract the growing roots towards this mineral wick acting as a soil moisturizer located deep in the son, and allow the large tap roots to pass therethrough without damage, said large roots having a diameter exceeding 1 cm, and being specialized in the function of water uptake. Its documented purpose is to prevent excessive congestion of tap roots in the interface zone located in the buffer zone between the water reserve and the son, thus triggering a trophic cascade that is beneficial to plant growth. Prior art such as U.S. Pat. No. 7,036273 teaches of an interface zone made of a particulate material such as vermiculite located in a basket with a plurality of ribs and narrow slots of a width comprised between 1.5 and 3.0 millimeters that unfortunately cannot allow the passage of all roots, thus allowing congestion in the interface zone. In this embodiment, root congestion becomes impossible.

The bioprocess works as follows : the soil medium 36 is first inoculated with vermicompost that provide microbial populations of PGPR micro-organisms 42, and second, with viable mycorhizal fungi propagules 51. The mycorhizal fungi propagules or spores germinate, and the mycelial filament then infects the root tissues of the plant, and aids the plant being able to access greater element nutrients from the soil (such as phosphorus, copper, iron, etc . . . ) These nutrients are basically insoluble in water, but with the use of the fungi, they become more water soluble, hence more easily bioavailable. Also, the development of the root system allows the plant to gain access to a larger volume of soil and thereby gain greater access to the nutritive elements and to come in direct contact with beneficial microorganisms.

Those beneficial microorganisms include opportunistic preemptive colonizers sues as mycorhization-helper bacteria and mycorhizae associated bacteria. They colonize the newly formed mycorhizal filament corning in contact with the root. These preemptive colonizers in turn recruit other micro-organisms of the PGP(group and start the formation of a bacterial mat, or biofilm, on the surface of the root and fungal filaments through the process of quorum sensing.

Meanwhile, PGPF 110 feed the ever expanding biofilm and encourage further plant growth. They also feed the lactic acid bacteria that condition the soil to pH values that inhibit overproliferation of putrefaction microbes, and leave the way for selected types of organic matter decomposers, such as lignicolous fungi, to decompose organic matter in a controlled manner, instead of at random.

Turning to FIG. 3, an individual cassette insert, or bioreactor element has an upper part and a lower part. The upper part contain either a thin layer of compost 36 for the purpose of greenhouse agriculture, or a thick layer of compost for the purpose of the cultivation of plants that produce large roots, such as potatoes or carrots, or for the cultivation of marsh plants for purposes of grey or brown water filtration.

In both cases, the bottom part of said bioreactor has a plurality of large apertures. Turning to the arrangement shown in FIGS. 3 and all others, the cassette inserts have an upper wall as well as lower walls with large apertures 41 that define the cavity containing soilless wicking medium. The large apertures should retain the wicking material 34, and are especially and intently designed to present a smooth arcuate surface to the roots, as they pass therethrough. Also, as previously mentioned, the material is preferably compliant in nature, i.e. it can be slightly deformed to easily permit the passage of roots therethrough without damaging them.

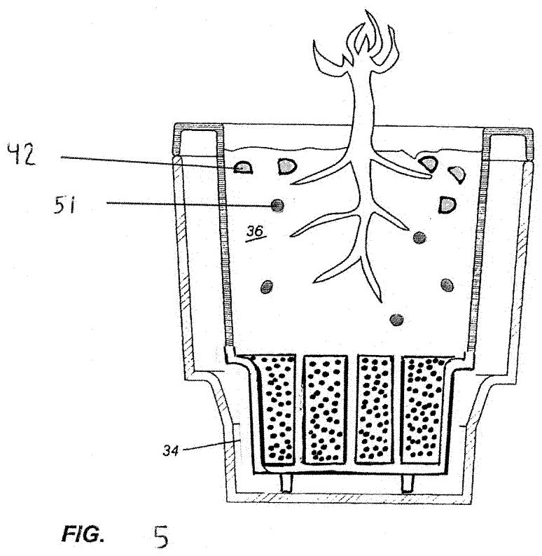

As shown in FIG. 5, a rnycorhizal inoculum 51 is added to the soil that already contains vermicompost and its rich and diversified PGPR microbial populations 42 ,

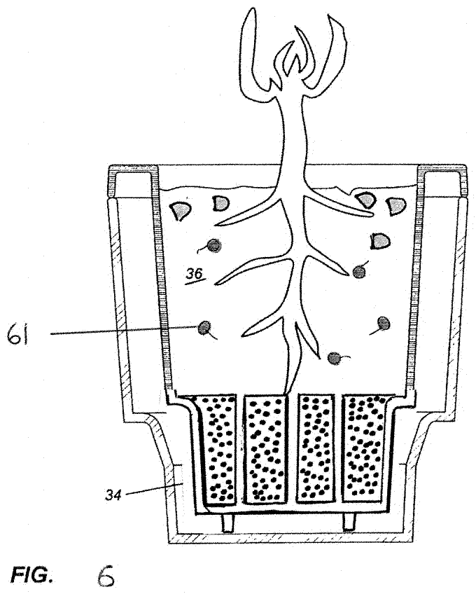

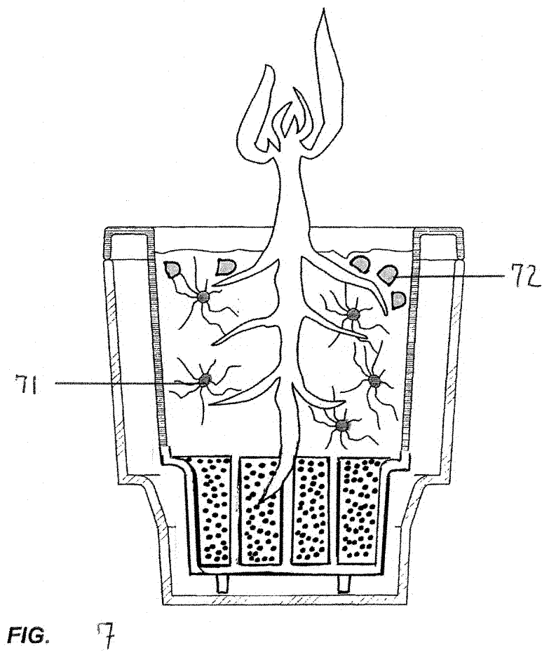

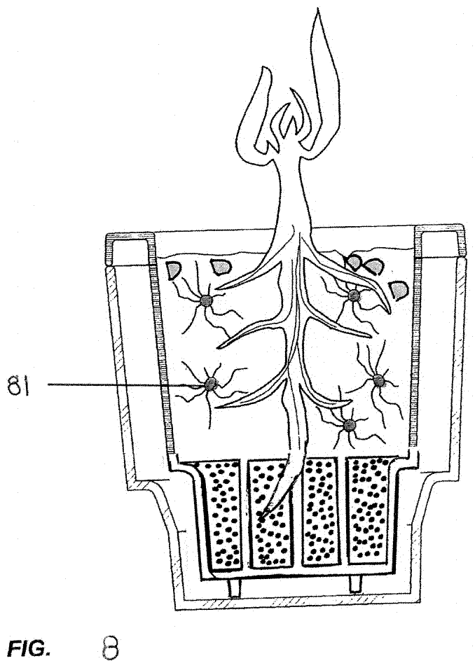

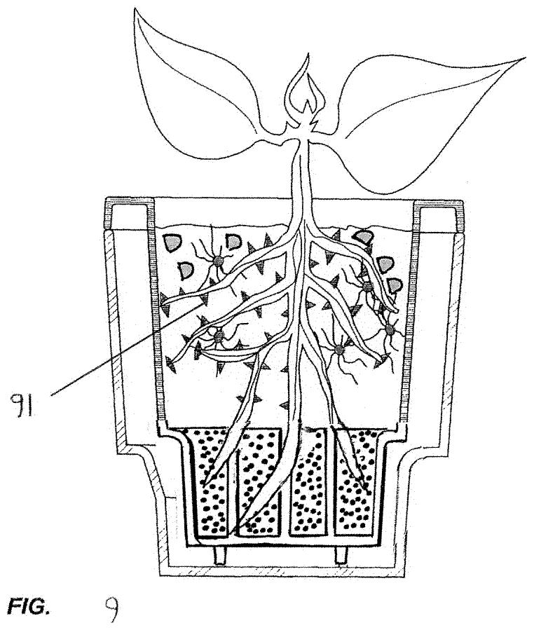

As shown in FIG. 6, following the placement of the mycorhizal inoculum, there is germination within the soil 61. As seen in FIG. 7, there is further mycorhizal growth leading to direct contact with the roots 71 and in the newly forming PGPR bacterial biofilm 72. FIG. 8 illustrates further infection of the inside of the root tissues 81 in the bioreactor environment. This is followed by FIG. 9 showing mycorhizal colonization of the entire root system as well as microbial colonization of the surface of the root system with MHA and MHB preemptive colonizer species 91.

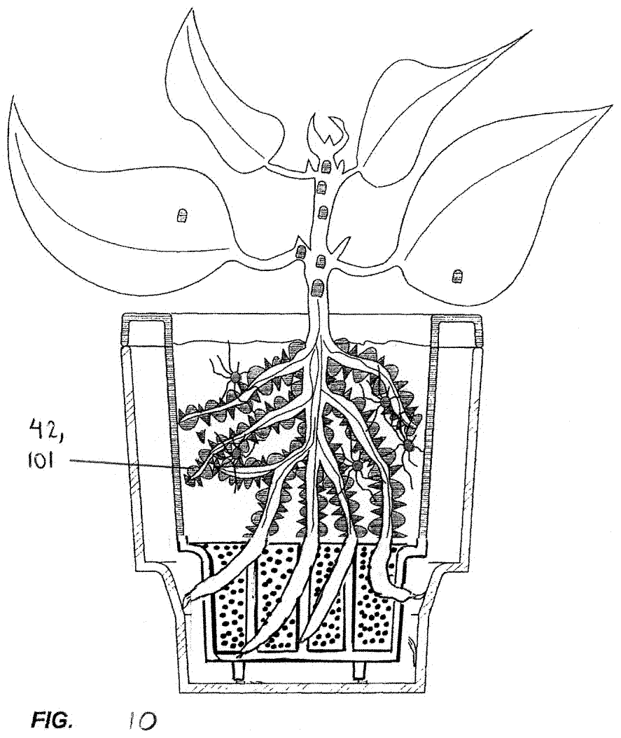

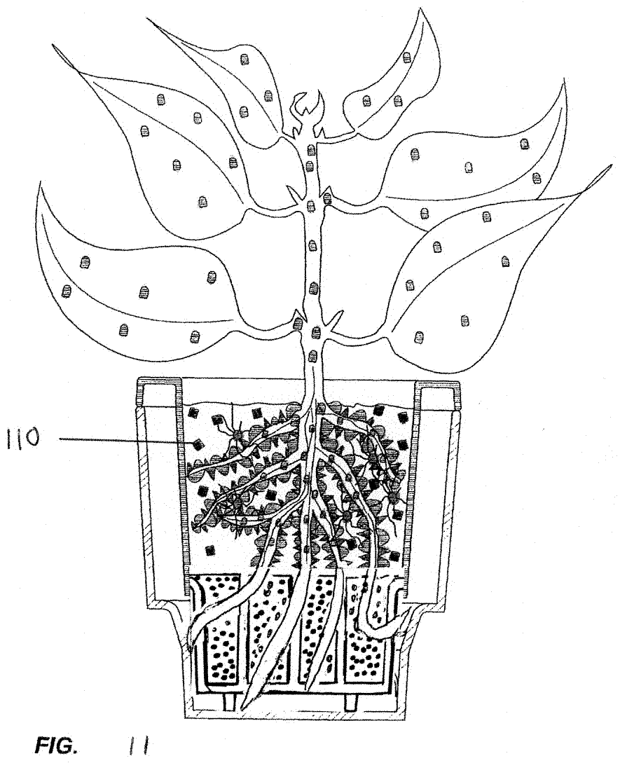

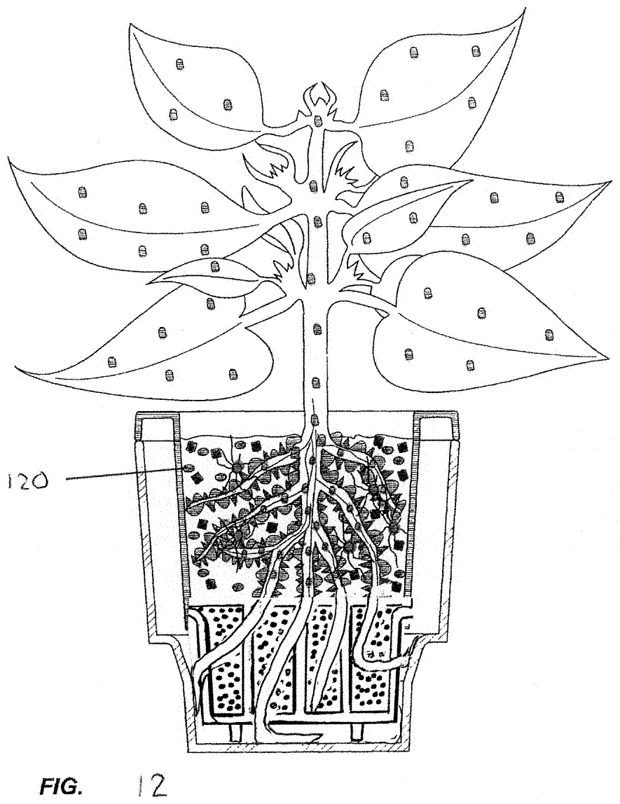

FIG. 10 shows the step of PGPR 42, bacterial endophyte 101 and fungal endophyte 101 recruitment by MHA and MAB preemptive colonizer species 91, and elaboration of an abundant PGPR biofilm 72 on root surfaces in the bioreactor environment. This is followed by FIG. 11 showing the step of PGPF nourishing action on colonized roots 110 and also theft further nourishing action on PGPR bacterial populations 42 and on SOB lactic acid producing bacterial populations 120 in the bioreactor environment. FIG. 12 shows the actions of SOB lactic acid bacteria populations 120 in the bioreactor environment. The SOB are soil conditioning bacteria more especially, lactic acid producing bacterial populations. One of theft functions is to keep a constant soil pH between 6 and 7.

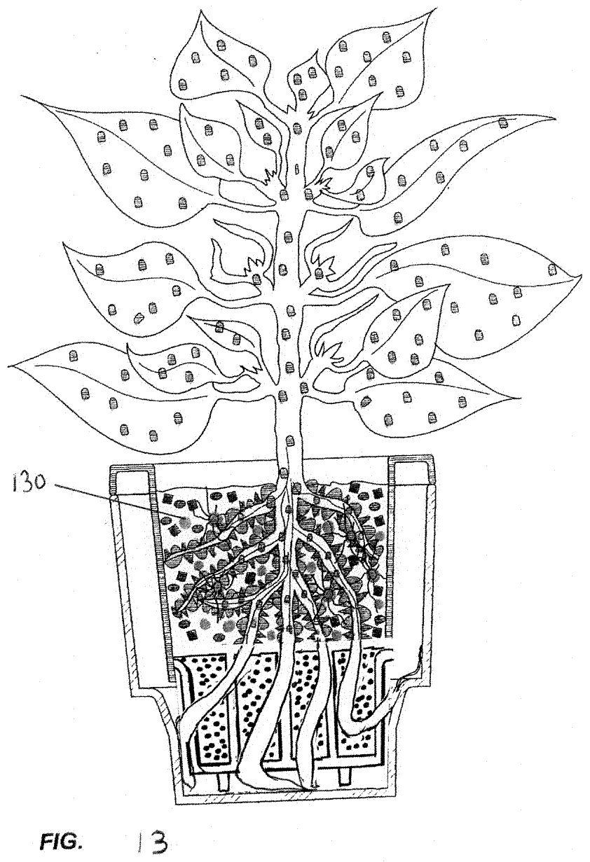

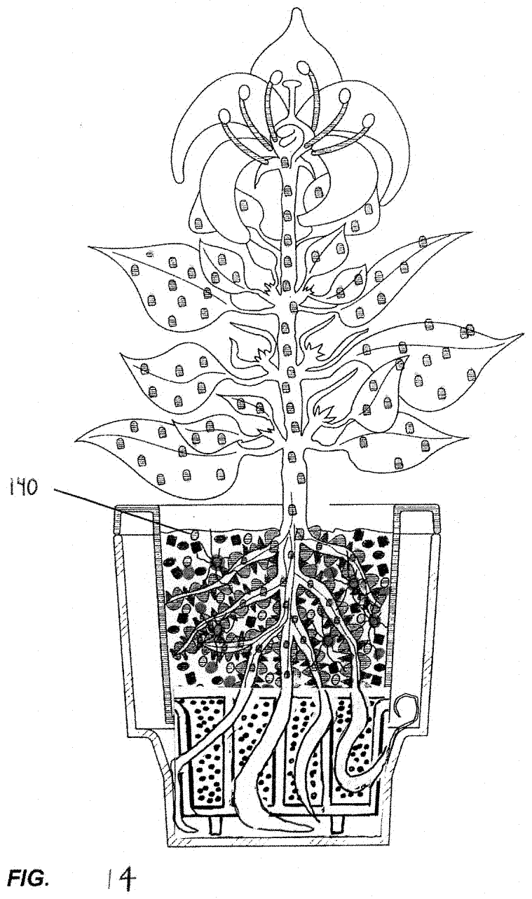

FIG. 13 shows the actions of PDB bacterial populations 130 in the bioreactor, such as purple non-sulphur bacteria, while FIG. 14 shows the step of PSHB probiotic action 140 in the bioreactor. These bacterial populations are natural elicitors of plant defense mechanisms against bacterial and fungal plant pathogens.

Gutter receivers can be placed on a side by side relationship in order to cover a large horizontal surface, such as a greenhouse. This arrangement can also be used for the purpose of bioremediation, as an urban or periurban modular filtrationmarsh, for the treatment of water waste (grey water and/or brown water). It can also be used for rooftop urban agriculture purposes. This arrangement is shown on FIG. 2.

It is indeed of primordial importance to provide a system in which water can be kept running at all times in a bioponic agriculture situation.

Turning to the preferred arrangement, there is provided a plant cultivation system comprising a series of individual gardening containers, a tank for containing water, a pump for allowing movement of water in the bottom of long receivers or individual specialized plant containers, a dripping system for allowing plants to get watered directly at the base through rnicroirrigation dripper s, solenoid valves and proportional fertilizer injectors as part of a complete organic greenhouse or homegrown agriculture infrastructure.

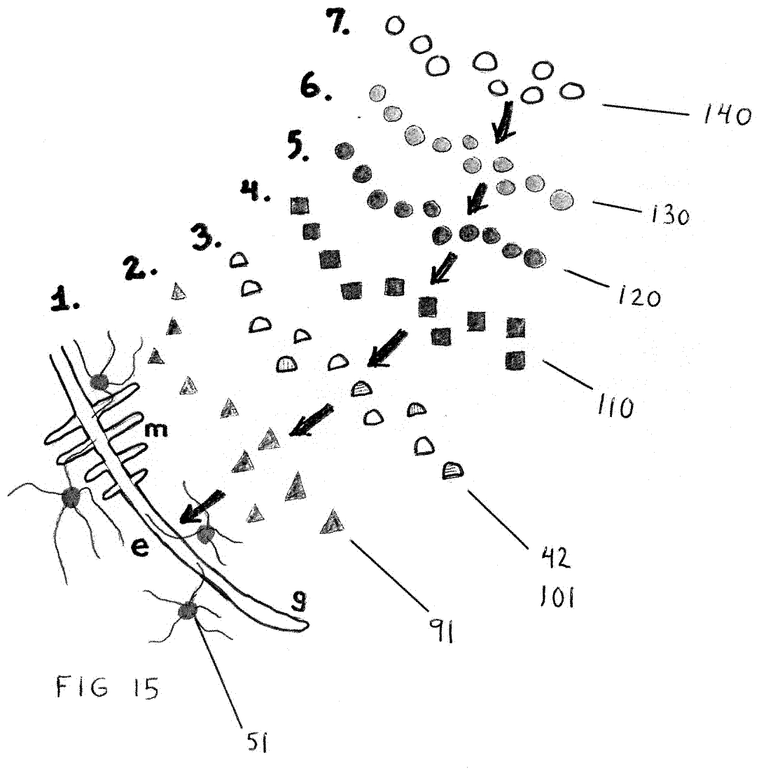

Turning to FIG. 15, there is illustrated a bioprocess comprising the 7 successive steps of microbial inoculation and rhizosphere conditioning that happens in an orderly manner in both space and time, and not at random. The microbial groups are indicated with their respective reference numerals 51, 91, 42, 101, 110, 120, 130 and 140.

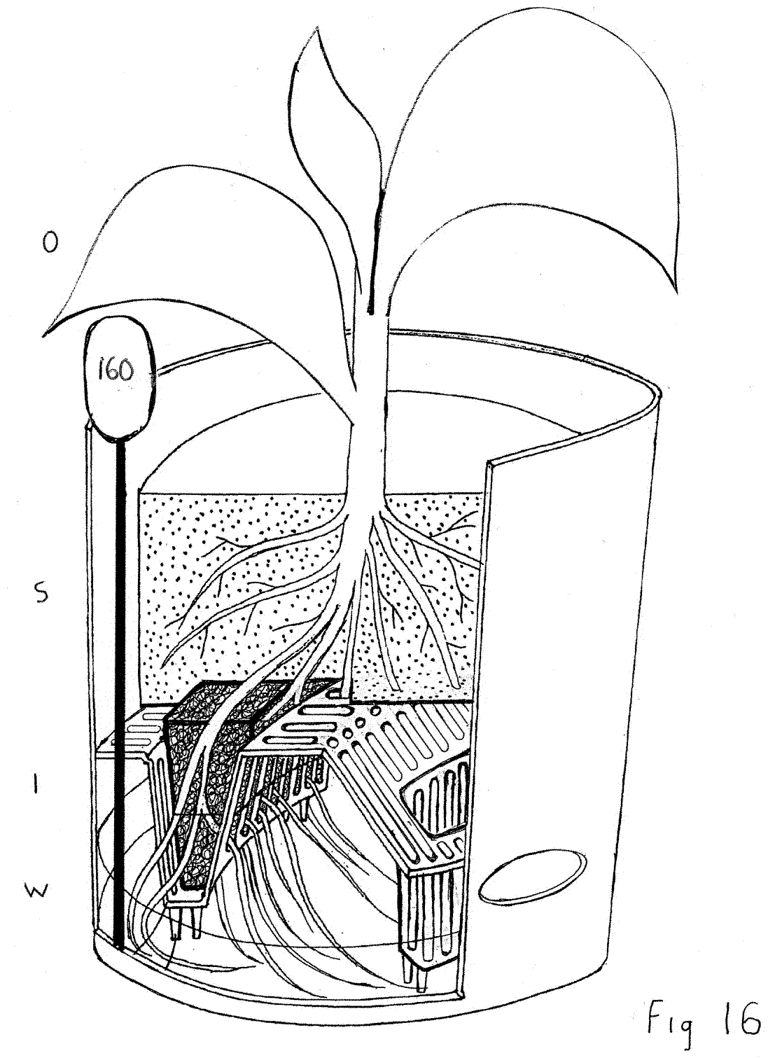

As well, turning to FIG. 16, there is illustrated an individual plant container comprising a water reserve (W) , an interface environment (I) , a soil compartment (S) and an outside environment (O) , said individual plant container being provided with an electronic monitoring system 160 comprising a series of precision sensors for the exact measurement of various selected environment parameters such as temperature, ionic conductivity, pHl, dissolved oxygen, humidity, dissolved carbon dioxide, dissolved ammonia and other chemical constituents found in any of all aforementioned four W, I, S and O environments, such sensors being placed along a strip that can be inserted in permanence along the inner side of an individual cylindrical container, or cassette insert. The superior part of the strip 160 that is not buried in the soil also comprises precision captors and transrnittors that can respectively recieve or send wireless radio monitoring signals to an electronic control device that can be found at a distance from the plant container, for integration of all parameters. The electronic control device should itself be coupled with an electronic wifi transduction device for effective wireless communication of all data to the user through wireless mobile applications. This numeric technology can be supplied with the strip sensors, thus allowing the user to be kept informed at all times on the physico-chernical parameters that characterize the complete plant growing installation, and thus allowing the user to perform any desired intervention at a distance for the proper maintenance of the aforementioned plant cultivation installation.

In a greenhouse installation, water can be recirculated at all times in a dosed loop system configuration through pumping action that should allow water movement as follows : it should be drawn from a large collection tank and pumped up to the other end of the system in a seies of distribution pipes in order to reach the lower part of each individual trough, for circulation in the bottom of each trough, before reaching a downwardly extending collector pipe falling in the collection tank, where the cycle can be repeated, thus keeping the water in a constant movement and a constant state of oxygenation that can be measured and monitored and intervened upon through the use of wireless sensors and mobile application devices. In parallel with the ever recirculating water at the bottom of the system for permanent hydration of the tap root system of plants, an entirely robotized watering system is provided for allowing automatic and reliable fertilizer and bacterial conditioners to each individual plant specimen. This should be done using solenoid valves activated by timers connected to the mobile application device for easy intervention by the grower. The flow of water has to be kept unidirectional through the blocking action of check valves and water has to reach the top part of each individual cassette insert or specialized container through dripping irrigation, directly on top of the thin compost phase at the base of the plants, for providing fertilizers and microorganisms to the superficial (nourishing) root system conveniently found and differentiated in the proximity of said dripping irrigation device. A series of modular gutter-supporting elements can be joined together in a series to be installed in a large enclosure for large scale greenhouse organic production. Turning to Fig, 17 A and 17 B, the bottom part of an individual cassette insert 17A can hold a brick of geotextile material 34 that allows root growth therethrough as shown in FIG. 17 B.

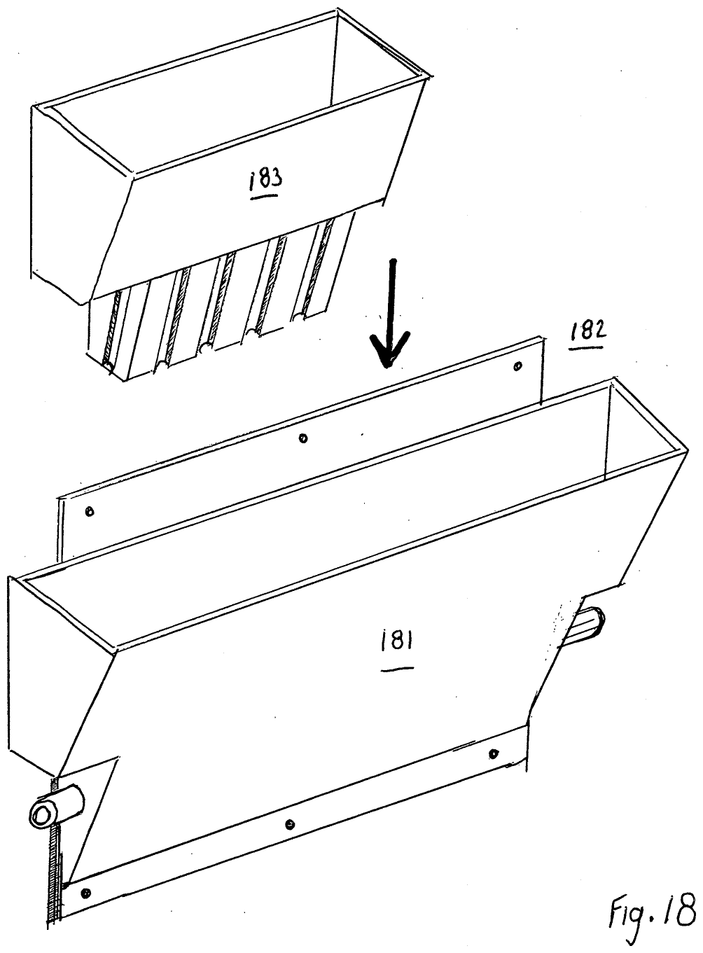

Turning to FIG. 18 , a green wall unit is composed of a reciever 181 at an angle of 45 degrees that can be placed solidly on a vertical wall surface 182 , said reciever containing one or a plurality of soil-containing inserts 183 in order to grow plants therein. A series of modular green wall units specially designed to create green wall installations can be joined together in a series and in parallel on many levels on a large wall for green walling purposes. Sensors and detectors of all kinds can be incorporated in the green wall installation in order to provide monitoring and intervention capabilities from a distance, using mobile apps on an intelligent cell phone, tablet or laptop computer.

It will be understood that the above described embodiments are for purposes of illustration only and that changes and modifications may be made thereto without departing from the spirit and scope of the inventio

1. A system and method for off-ground plant cultivation, including container devices and green walling devices, comprising the steps of providing a plant growing system having a reciever container and an insert therefore, said insert having a wall with wide apertures defining a cavity filled with a hydrophilic mineral-based wicking geotextile material to permit root growth therethrough, said insert being spaced from a bottom of said container;
Placing a mineral-based geotextile wicking material into said insert, placing a soil on top of said mineral based wicking geotextile material, supplying water to said container;
Supplying a microbial inoculant containing at least one species from each of the following groups of microorganisms :
A) Arbuscular Mycorhizae
B) Mycorhizae Associated Bacteria (MAB)
C) PGPR microorganisms found naturally in vermicompost
D) PGPF yeasts; and
E) SCB.

2. A system and method of green walling comprising the steps of providing a plant growing system having a reciever container placed at a 45 degree angle relative to a vertical supporting wall, and providing an insert therefore, said insert having a wall with wide apertures defining a cavity filled with a hydrophilic geotextile wicking material to permit root growth therethrough, said insert being spaced from a bottom of said container;
Placing a mineral based geotextile into said insert, placing a soil on top of said mineral based geotextile, supplying water to said container;
Supplying a microbial inoculant containing at least one species from each of the following groups of microorganisms :
A) Arbuscular Mycorhizae
B) Mycorhizae Associated Bacteria (MAB)
C) PGPR microorganisms found naturally in vermicompost
D) PGPF yeasts; and
E) SCB.

3. The method of claim 1 wherein said microbial inoculant is supplied to a plant on a repeat basis

4. The method of claim 1 wherein said inoculant is supplied at intervals of between 5 and 10 days

5. The method of claim 1 further including the step of watering plants in said insert to provide nutrients directly at the base of the plant

6. The method of claim 1 wherein said PGPR populations are found in vermicompost.

7. The plant growing system of claim 1 wherein interface material is made of a water absorbing , thick wicking geotextile material with a loose mesh material that allows root growth therethrough.

8. The plant growing system of claim 1 wherein interface apertures are of a size between 4 and 40 mm.

9. The plant growing system of claim 1 wherein interface material is not of an organic nor granular nature, but either mineral based, spongious or fibrous nature.

10. The plant growing system of claim 1 wherein microbial consortium is of a liquid nature, and comprising concentrated, stable living and immediately bioactive microorganisms instead of being on an inert,. sporulated state.

11. The plant growing system of claim 1 wherein vermicompost is used.

12. The plant growing system of claim 1 wherein a perfectly aerobic environment for soil microflora and inoculum is provided, in order to achieve optimal equilibrium between all soil microbial populations for appropriate soil ecology around nourishing roots differentiated in the interface environment.

13. The plant growing system of claim 1 wherein glass wool cubes are used as a non-soil root forming interface growing medium.

14. The plant growing system of claim 1 wherein fiberglass insulating mineral wool material is used as a non-soil root forming interface growing medium

15. A combination of micro-organisms to be used in the plant culture system and method of claim 1, said combination of microorganisms being found in a microbial inoculum, said combination of microorganisms being expressly designed to enhance the biological activity of worm cast manure compost (vermicompost).

16. A combination of micro-organisms to be used in the plant culture system and method of claim 1 said combination of microorganisms being expressly designed to enhance plant growth and health without the use of pesticides.

17. The plant culture system and method of claim 1 wherein PGPR populations found in vermicompost are stabilized by the actions of specific strains of lactic acid bacteria found in an active form as a stable, ready to use liquid concentrated microbial consortium.

18. The plant culture system and method of claim 1 wherein PGPR populations found in vermicompost are stabilized by the combined actions of specific strains of beneficial yeasts and lactic acid bacteria living together in an active form as a stable, ready to use liquid concentrated microbial consortium.

19. The plant culture system and method of claim 1 wherein volatile organic compounds originating from the putrefaction of complex organic molecules found in biological fertilizers are terminally metabolized by purple non-sulfur bacteria found in an active form as a stable, ready to use liquid concentrated microbial consortium.

20. The plant culture system and method of claim 1 wherein the provided microbial consortium is expressly designed to avoid uncontrolled putrefaction of organic material, promote optimal crop yields and elicit natural plant defense mechanisms against plant pathogens and prevent insect larval proliferation such as mosquitoes in water reserve.

21. The plant culture system and method of claim 1 the design of which can create a new, hybrid version of a «soil-on-a-shelf» and a «soil-in-a-bag» green walling modular system, called «soil-in-an-insert» type system.

22. The plant culture system and method of claim 1 wherein three distinct rhizosphere zones are provided, the top one being occupied by filamentous fungi, arbuscular mycorhizae and sessile bacteria fixed on root hairs, the middle one being occupied by preemptive colonizers found in a sessile form on inert fiberglass interface geotextile material, and the bottom one being occupied by motile bacterial species living freely in the water reservoir.
